(19) United States
(12) Patent Application Publication
(10) Pub. No.: US 2024/0247764 A1
(43) Pub. Date: Jul. 25, 2024

(54) TANK MODULE

(71) Applicant: TOYOTA JIDOSHA KABUSHIKI KAISHA, Toyota-shi (JP)

(72) Inventor: Takahiro AWAI, Toyota-shi (JP)

(73) Assignee: TOYOTA JIDOSHA KABUSHIKI KAISHA, Toyota-shi (JP)

(21) Appl. No.: 18/499,465

(22) Filed: Nov. 1, 2023

(30) Foreign Application Priority Data
Jan. 25, 2023 (JP) 2023-009349

(51) Int. Cl. F17C 13/08

(52) U.S. Cl. CPC F17C 13/08; F17C 2205/0107; F17C 2205/013

(57) ABSTRACT

A tank module comprises a tank and a holding device for holding the tank. The tank is provided with mouthpieces at both ends thereof, and is arranged so that one mouthpiece is on the bottom and the other mouthpiece is on the top. The holding device comprises a frame and a support member arranged below the frame and supporting the tank. The support member has a hole into which the mouthpiece underlying the tank is inserted, and a recess that supports a portion of the body of the tank around the hole. The tank is supported by the support member so that the mouthpiece arranged in the hole of the support member does not come into contact with the frame.

### CROSS-REFERENCE TO RELATED APPLICATION

This application claims priority to Japanese Patent Application No. 2023-009349 filed on Jan. 25, 2023, incorporated herein by reference in its entirety.

### BACKGROUND

### 1. Technical Field

The present disclosure relates to a tank module including a tank and a unit for holding the tank.

### 2. Description of Related Art

Japanese Unexamined Patent Application Publication No. 2019-98802 (JP 2019-98802 A) discloses a tank mounting structure in which a tank is held by a frame and a band.

### SUMMARY

Tanks are generally placed horizontally, but it is conceivable that tanks are placed vertically because of the installation space or from the viewpoint of efficiently increasing the amount of hydrogen stored per unit floor area. When the tank is placed vertically, on the other hand, an end (lower end) of the tank such as a mouthpiece placed on the lower side is burdened by vibration applied to the tank during movement or use, and there is a risk that the durability of the tank is reduced.

In view of the above problem, an object of the present disclosure is to provide a tank module that can suppress a decrease in durability by suppressing a burden on a tank even when the tank is placed vertically.

The present application provides a tank module including a tank and a holding device that holds the tank, in which:
the tank is provided with mouthpieces at both ends of the tank, and is disposed such that one of the mouthpieces is located on a lower side and the other mouthpiece is located on an upper side;
the holding device includes a frame and a support member disposed at a lower portion of the frame to support the tank;
the support member has a hole into which the mouthpiece on the lower side of the tank is to be inserted, and a recess that supports a part of a main body of the tank around the hole; and
the tank is supported by the support member without the mouthpiece disposed in the hole of the support member contacting the frame.

In the tank module,
the recess of the support member may have a curved surface that conforms to a dome-shaped side end portion of the tank, and the recess may support the side end portion.

In the tank module,
the hole of the support member may be shaped to catch the mouthpiece so that the tank does not rotate about an axis.

In the tank module,
the support member may be made of an elastic material.

In the tank module,
the frame may have an opening at a portion facing the mouthpiece disposed on the support member.

According to the present disclosure, it is possible to suppress a load applied to a mouthpiece of a tank, even when the tank is structured to be arranged vertically, since the weight of the tank is not applied to the mouthpiece of the tank, and to improve the durability of the tank module.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a diagram showing the configuration of the tank module 10;

FIG. 1B is a diagram showing the configuration of the tank module 10;

FIG. 1C is a diagram showing the configuration of the tank module 10;

FIG. 2 is a diagram showing the configuration of the tank 20;

FIG. 3A is a diagram showing a part of the cross section of the tank module 10;

FIG. 3B is a diagram showing a part of the cross section of the tank module 10;

FIG. 4A is a diagram for explaining the support member 13;

FIG. 4B is a diagram for explaining the support member 13; and

FIG. 5 is a diagram for explaining a tank module of another embodiment.

### DETAILED DESCRIPTION OF EMBODIMENTS

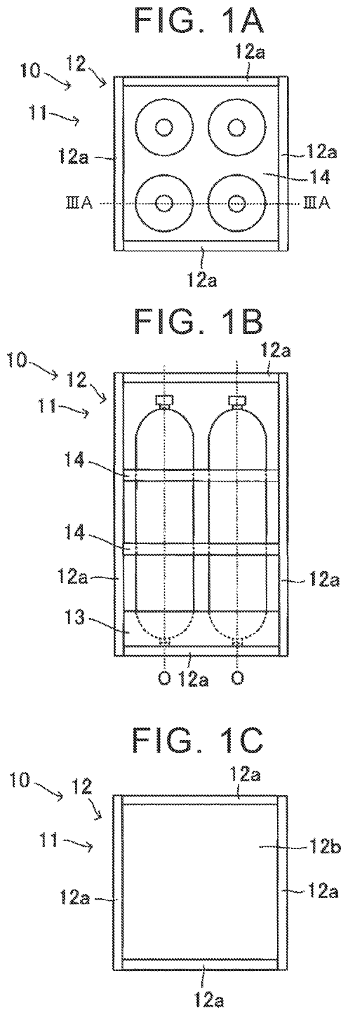

FIGS. 1A, 1B and 1C depict the configuration of the tank module 10 of the present disclosure. FIG. 1A is a plan view of the tank module 10. FIG. FIG. 1B is a front view of the tank module. FIG. 1C is a bottom view of the tank module. In the front view of

FIG. 1B, the upper and lower sides of the tank module 10 are vertical, the lower side is the ground, and the upper side is the sky. As can be seen from FIGS. 1A, 1B and 1C, the tank module 10 has a holding device 11 and a high pressure tank 20 arranged on the holding device 11.

### 1. High Pressure Tank Structure

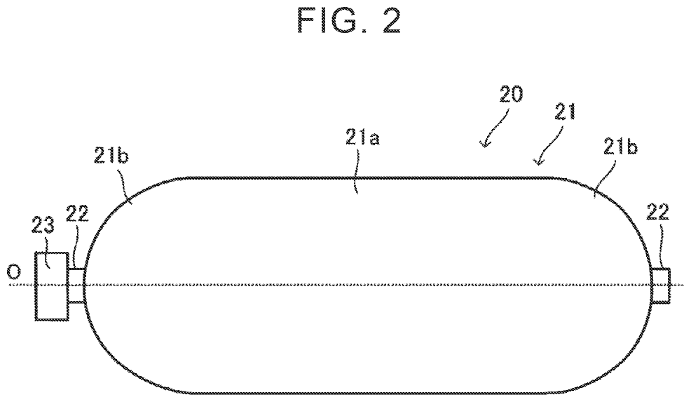

FIG. 2 schematically shows the appearance of a high-pressure tank 20 according to one form. The form of the high-pressure tank is not particularly limited, and a known form can be used. However, the high-pressure tank 20 according to the form includes a tank body 21, mouthpieces 22, and a valve 23.

### 1.1. Tank Body

The tank body 21 is a part that forms a region for storing a fluid to be stored (a storage medium such as hydrogen). The tank body 21 is cylindrical (axis O) having a cavity. A storage medium is deposited inside this cavity. The tank body 21 has a body portion 21a having a substantially constant diameter. Openings at both ends of the body portion 21a are narrowed by dome-shaped side end portions 21b. A mouthpiece 22 is arranged in the narrowed opening. The tank body 21 has a laminated structure consisting of a liner, a reinforcing layer, and a protective layer from the inside.

The liner is a hollow member that constitutes the inner wall of the tank body 21 and partitions the internal space. The liner may be constructed of a material capable of holding the storage medium in its interior space without leaking. Known materials can be used for the liner, and examples include nylon resin, polyethylene-based resin, and metals such as stainless steel and aluminum. Although the thickness of the liner is not particularly limited, it is preferably 0.5 mm to 1.0 mm.

Among them, the liner is preferably made of resin from the viewpoint of being able to exhibit the effects of the present disclosure more remarkably.

The reinforcing layer has a plurality of layers of fibers laminated and resin impregnated into the fibers and cured. The layers of the fibers are constructed by winding a number of layers of fiber bundles up to a predetermined thickness on the outer surface of the liner. The thickness of the reinforcing layer is determined by the required strength and is not particularly limited, but is about 10 mm to 30 mm.

Carbon fibers are used for the fiber bundles of the reinforcing layer, and the fiber bundles are band-like having a predetermined cross-sectional shape (for example, a rectangular cross-section) formed by bundling the carbon fibers. The cross-sectional shape of the fiber bundle is not specifically limited, but the cross-sectional shape may be a rectangle with a width of about 6 mm to 10 mm and a thickness of about 0.1 mm to 0.15 mm. Although the amount of carbon fibers contained in the fiber bundle is not particularly limited, the fiber bundle may contain, for example, about 36000 carbon fibers.

The resin impregnated into the fibers in the reinforcing layer and cured is not particularly limited as long as it can increase the strength of the fibers. Examples of such resins include thermosetting resins that are cured by heat. Examples of thermosetting resins include amine-based or anhydride-based curing accelerators and rubber-based reinforcing agents. Examples include epoxy resins and unsaturated polyester resins. Other examples of the above-mentioned resins include resin compositions in which an epoxy resin is used as a main component, and a curing agent is mixed with the epoxy resin to cure the resin composition. According to this method, the resin composition, which is the mixture, reaches and permeates the fiber layer between the time when the main agent and the curing agent are mixed and before curing, and then automatically cures.

Due to the reinforcing layer as described above, the weight of the high-pressure tank 20 can be reduced while the strength thereof is maintained.

A protective layer is a layer arranged on the outer circumference of the reinforcing layer as needed. When the protective layer is provided, for example, glass fibers are wound around the reinforcing layer, and the glass fibers are impregnated with a resin.

The impregnated resin can be considered similar to the reinforcing layer 12. Thereby, impact resistance can be imparted to the high-pressure tank 20. Although the thickness of the protective layer is not particularly limited, it can be about 1.0 mm to 2.0 mm.

### 1.2. Mouthpiece

The mouthpieces 22 are members attached to two open ends formed at the side end portions 21b of the cylindrical tank body 21, respectively. One of the two mouthpieces 22 functions as an opening that communicates the inside and outside of the high-pressure tank 20 and functions as a mounting portion for mounting a pipe and a valve 23 (valve) to the high-pressure tank 20 . The other mouthpiece 22 is sealed so as to restrict communication between the tank body 21 and the outside. As understood from FIG. 2, the mouthpiece 22 is arranged so that one end thereof protrudes from the tank body 21. In this embodiment, the high-pressure tank 20 has the axis O of the tank body 21 aligned with the direction connecting the central axes of the two mouthpieces 22 provided on the tank body 21.

### 1.3. Valve

The valve 23 is arranged on one of the two mouthpieces 22, and switches between permitting and restricting the storage medium in and out of the tank body 21. The specific form of the valve 23 is not particularly limited, and a known form can be used.

### 2. Structure of the Holding Device

The holding device 11 is a device for holding the high-pressure tank 20, and includes a frame 12, a support member 13, and an auxiliary member 14.

### 2.1. Frame

The frame 12 is a member that forms the outer shell of the holding device 11, and a rectangular parallelepiped frame is formed by framing a plurality of frame members 12a, and the high-pressure tank 20 is arranged within the frame. Therefore, the frame members 12a are arranged at the parts forming the sides of the rectangular parallelepiped, and the parts corresponding to the faces of the rectangular parallelepiped are open. With respect to such a rectangular parallelepiped formed by the frame member 12a, in this embodiment, a portion corresponding to one surface is positioned so as to face the ground, and a portion corresponding to the opposite surface faces the sky.

Furthermore, in the present embodiment, the frame 12 has a face member 12b arranged at a portion corresponding to a surface of the rectangular parallelepiped facing the ground. That is, the face member 12b is disposed within a frame surrounded by the frame member 12a at the relevant portion to form a bottom plate.

### 2.2. Support Member

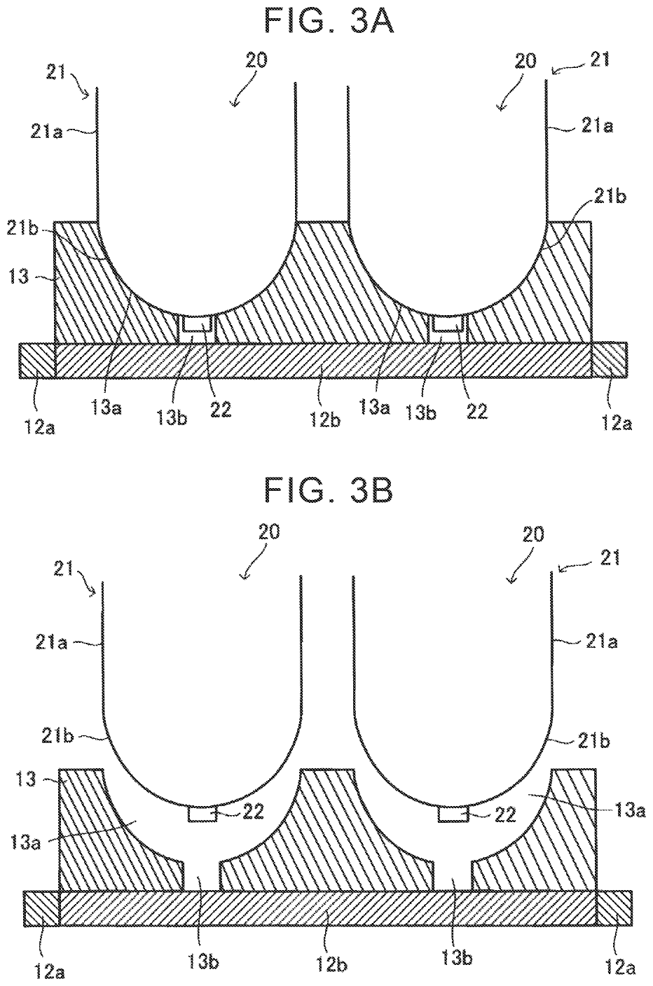

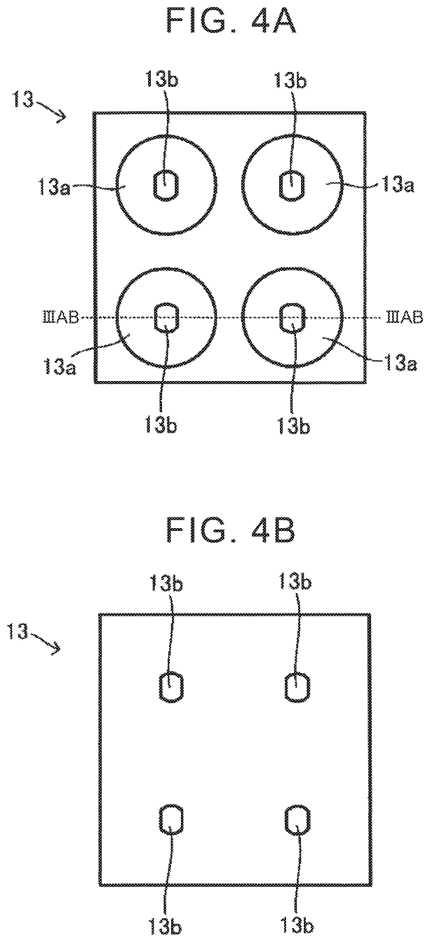

The support member 13 is a member arranged below the inside (inside of the rectangular parallelepiped) formed by the frame 12, and supports the lower portion of the high-pressure tank 20 from below, as will be described later. FIG. 3A is a view focusing on the lower part of the holding device 11 cut along the line indicated by IIIA-IIIA in FIG. 1A (the high pressure tank 20 is not shown in section in this view). FIG. 3B shows the same view as FIG. 3A, but shows the holding device 11 and the high pressure tank 20 separately for clarity. A plan view of the support member 13 is also shown in FIG. 4A. A bottom view of the support member 13 is shown in FIG. 4B. The end face of the support member 13 appearing in FIGS. 3A and 3B is a cross section along line IIIAB-IIIAB in FIG. 4A. As understood from these figures, the support member 13 is a block-shaped member.

The support member 13 is provided with a recess 13a on one surface thereof. The side end portion 21b of the tank body 21 of the high-pressure tank 20 is inserted into the recess 13a to support the side end portion 21b, as will be described later. Accordingly, the recess 13a preferably has a shape that makes it difficult for a gap to form when the side end portion 21b of the tank body 21 contacts the recess 13a, although this is not a limitation. The recess 13a preferably has a shape (a circular shape whose diameter corresponds to the outer diameter of the tank body 21) along the shape of the tank body 21 in plan view, and preferably has a curved surface along the dome shape of the side end portion 21b of the tank body 21 in the depth direction.

The depth of the recess 13a is not particularly limited as long as it can support at least part of the side end portion 21b of the tank body 21. It is preferable that the depth of the recess 13a be such that the entire side end portion 21b, which is the lower side of the tank body 21, can be contacted and supported.

The support member 13 further has a hole 13b penetrating to the opposite surface of the support member 13 at the deepest part of the recess 13a. That is, a recess 13a is formed around the hole 13b.

One (lower) mouthpiece 22 of the high-pressure tank 20 is inserted into the hole 13b as will be described later. The mouthpiece 22 inserted into the hole 13b is preferably the side on which the valve 23 is not arranged.

In the support member 13 of this embodiment, the depth of the hole 13a is configured to be deeper than the protrusion amount of the mouthpiece 22 protruding from the tank body 21. As a result, the entire mouthpiece 22 protruding from the tank body 21 can be accommodated inside the hole 13a.

The plan view shape of the hole 13a is preferably a non-circular shape as shown in FIGS. 4A and 4B. However, the reason for this non-circular shape is that the high-pressure tank 20 has a shape that catches the mouthpiece 22 in order to restrict the rotation of the high-pressure tank 20 around the axis O. The plan view shape of the hole 13a can be appropriately set corresponding to the shape of the mouthpiece 22 so that this purpose can be achieved. In this embodiment, as shown in FIGS. 4A and 4B, a part of the circular shape is notched, and linear portions parallel to each other are formed so as to face each other across the center of the circular shape.

The size of the hole 13a in a plan view can be determined from the viewpoint of ease of insertion of the mouthpiece 22 into the hole 13a and regulation of rotation of the mouthpiece 22 about the axis O, but is not particularly limited. It is preferable that the size of the hole 13a in plan view is slightly larger than the outer shape of the mouthpiece 22.

A material constituting the support member 13 is not particularly limited.

From the viewpoint that the support member 13 can absorb the vibration applied to the high-pressure tank 20, the material forming the support member 13 is preferably an elastic body. More specifically, examples of elastic materials include natural rubber, nitrile-butadiene rubber, and ethylene-propylene rubber.

Since this embodiment holds four high-pressure tanks 20, one support member 13 is provided with four recesses 13a and four holes 13b. However, the number of recesses 13a and holes 13b can be matched to the number of high-pressure tanks 20 to be installed. Further, in this embodiment, one support member 13 is provided with a plurality of recesses 13a and holes 13b, but the present disclosure is not limited to this. A plurality of support members each having one recess 13a and one hole 13b may be arranged in one holding device.

### 2.3. Auxiliary Member

The auxiliary member 14 is a member that is provided as required. The auxiliary member 14 is a member that is fixed to the frame 12 and assists in holding the high-pressure tank 20. The auxiliary member 14 of this embodiment is a plate-like member arranged so as to block the axis O of the high-pressure tank 20 arranged. The auxiliary member 14 is provided with a hole through which the body portion 21a of the tank body 21 of the high-pressure tank 20 is passed. Thus, in this embodiment, the auxiliary member 14 assists in supporting the body portion 21a of the tank body 21. As a result, sway or the like of the high-pressure tank 20 can be suppressed.

The auxiliary member 14 may be provided as required, and if the support member 13 alone can sufficiently hold the high-pressure tank, the auxiliary member 14 is not necessarily provided. Although not particularly limited, for example, when the length of the high-pressure tank 20 in the axial direction is considerably larger than the outer diameter of the high-pressure tank 20 (for example, 10 times or more), the effect of the auxiliary member 14 appears remarkably.

### 3. Placement of High-Pressure Tanks, Effects, etc.

The high-pressure tank 20 is held by the holding device 11 as described above. In this embodiment, the four high-pressure tanks 20 are placed inside the rectangular parallelepiped framework of the frame 12 of the holding device 11 so that their axes O are substantially parallel to the vertical direction, that is, the so-called high-pressure tanks 20 are placed vertically. At this time, the mouthpiece 22 on the side of the high-pressure tank 20 where the valve 23 is not arranged is inserted into the hole 13b of the support member 13. The side end portion 21b on the mouthpiece 22 side is held in close contact with the inner surface of the recess 13a. As a result, the high-pressure tank 20 is supported by the support member 13, and vibrations are also absorbed.

In this embodiment, since the depth of the hole 13b of the support member 13 is set to be greater than the amount of projection of the mouthpiece 22, the mouthpiece 22 is included in the hole 13b without protruding from the support member 13, and the mouthpiece 22 is configured not to touch the face member 12b of the frame 12. Therefore, even if the high-pressure tank 20 is arranged vertically, the weight of the mouthpiece 22 is not applied, and the load can be greatly reduced.

In this embodiment, the mouthpiece 22 is configured so as not to come into contact with the face member 12b. However, when the mouthpiece 22 comes into contact with the face member 12b due to vibration or the like, or when the mouthpiece 22 is configured to always touch the face member 12b, an elastic material that is the protection member may be provided between the face member 12b and the mouthpiece 22. The material of the protective member can be considered similar to the support member described above.

Further, since the support member 13 is arranged in the holding device 11 in advance, it is not necessary to arrange a protector at the lower end of the high-pressure tank 20, which is advantageous in terms of workability and cost.

### 4. Other Form Examples

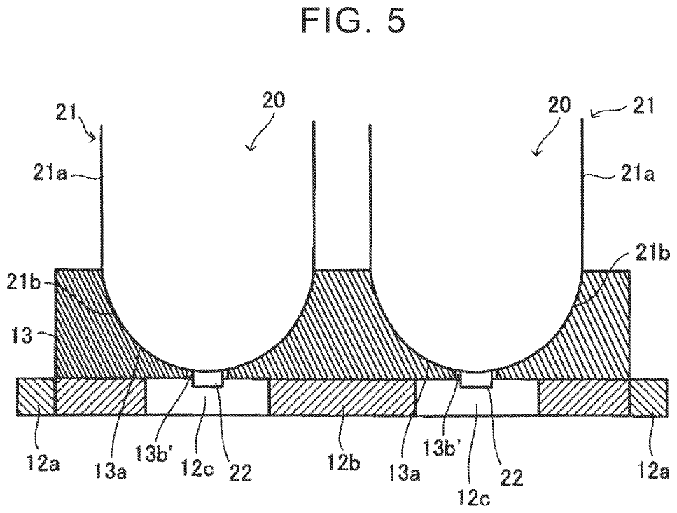

FIG. 5 shows a diagram for explaining another form example. FIG. 5 is a diagram shown from the same perspective as FIG. 3A. In this other embodiment, the depth of the hole 13b′ of the support member 13 is smaller than the amount of projection of the mouthpiece 22, and the face member 12b of the frame 12 is provided with an opening 12c. This opening 12c is provided at a position corresponding to the portion where the mouthpiece 22 is arranged.

In such another embodiment, the mouthpiece 22 is arranged to protrude from the lower surface of the support member 13 as shown in FIG. 5. The projecting portion is arranged in the opening 12c of the face member 12b. As a result, the mouthpiece 22 does not come into contact with the frame 12, so that the other embodiment has the same effect as the above-described embodiment.

What is claimed is:

1. A tank module comprising a tank and a holding device that holds the tank, wherein:
the tank is provided with mouthpieces at both ends of the tank, and is disposed such that one of the mouthpieces is located on a lower side and the other mouthpiece is located on an upper side;
the holding device includes a frame and a support member disposed at a lower portion of the frame to support the tank;
the support member has a hole into which the mouthpiece on the lower side of the tank is to be inserted, and a recess that supports a part of a main body of the tank around the hole; and
the tank is supported by the support member without the mouthpiece disposed in the hole of the support member contacting the frame.

2. The tank module according to claim 1, wherein the recess of the support member has a curved surface that conforms to a dome-shaped side end portion of the tank, and the recess supports the side end portion.

3. The tank module according to claim 1, wherein the hole of the support member is shaped to catch the mouthpiece so that the tank does not rotate about an axis.

4. The tank module according to claim 1, wherein the support member is made of an elastic material.

5. The tank module according to claim 1, wherein the frame has an opening at a portion facing the mouthpiece disposed on the support member.
